(19) United States
(12) Patent Application Publication
(10) Pub. No.: US 2011/0083384 A1
(43) Pub. Date: Apr. 14, 2011

(54) CHANGING THE TEMPERATURE OF A THERMAL LOAD

(76) Inventor: Geoffrey Russell-Smith, Nottingham (GB)

(21) Appl. No.: 12/997,520

(22) PCT Filed: Mar. 20, 2009
(86) PCT No.: PCT/GB09/00756

§ 371 Date: Dec. 10, 2010

(30) Foreign Application Priority Data
Jun. 10, 2008 (GB) 0810548.8

(51) Int. Cl. E04B 1/70; F28D 15/00; B28B 1/14; E04B 1/16

(52) U.S. Cl. 52/302.1; 165/104.11; 165/104.19; 52/745.19

(57) ABSTRACT

A method of controlling the temperature of a thermal load within a structure (50), including providing a structural member (10) which has a high thermal mass, the temperature of the thermal load being controlled by permitting thermal energy transfer between the structural member (10) and the thermal load, the method including providing the structural member (10) with at least one duct (18) for receiving a supply of air, and an outlet (26) for enabling the supply of air to flow from the duct (18) to the thermal load, so as to enable convective thermal energy transfer between the air passed along the duct (18) and the thermal load, wherein the thermal energy transfer between the air passed along the duct (18) and the thermal load is controlled by adjusting the temperature of the air passed along the duct (18), the method further including providing a conduit (32) for carrying thermal energy transfer fluid in the duct (18), the conduit (32) being in thermal contact with the duct (18) of the structural member (10) and the air passing through the duct (18).

This invention relates to apparatus for and a method of changing the temperature of a thermal load.

It is preferable to maintain a substantially constant temperature of the air in a building for the comfort of the occupants. The number of occupants, solar gain, and the amount of electrical equipment in use in a building, for examples, can increase the temperature of the air in the building, leading to the discomfort of the occupants. Diurnal and seasonal temperature variations also affect the temperature of the air in the building, and it is known to attempt to overcome these temperature variations by providing heating and/or air conditioning units to modify the temperature of the air inside a building.

A known method of modifying the temperature of the air and or objects in a structure (i.e. the thermal load of the structure) utilises hollow cores of structural members, such cores being provided to reduce the weight of such members. Such hollow core members are frequently used to erect structures, for example forming all or part of any of the walls, ceilings and floors. External ambient air is passed through at least some of the hollow-cores of one or more structural members, and the air is permitted to be passed from the structural members into the room(s) of the building, so that the air is able to exchange thermal energy with the air inside the room(s), and hence modify the temperature of the air inside the room(s).

According to the present invention, there is provided a method of controlling the temperature of a thermal load within a structure, including providing a structural member which has a high thermal mass, the temperature of the thermal load being controlled by permitting thermal energy transfer between the structural member and the thermal load, the method including providing the structural member with at least one duct for receiving a supply of air, and an outlet for enabling the supply of air to flow from the duct to the thermal load, so as to enable convective thermal energy transfer between the air passed along the duct and the thermal load, wherein the thermal energy transfer between the air passed along the duct and the thermal load is controlled by adjusting the temperature of the air passed along the duct, the method further including providing a conduit for carrying thermal energy transfer fluid in the duct, the conduit being in thermal contact with the duct of the structural member and the air passing through the duct.

Enabling fluid to be passed through the conduit in the duct in thermal contact with the duct of the structural member enables fluid passed through the conduit to transfer thermal energy from/to both the supply of air and from/to the structural member. This enables the temperature of the thermal load to be controlled accurately, since the temperature of the thermal load can be adjusted quickly. Providing the conduit for thermal energy transfer fluid inside the duct enables the conduit to be retrofitted to existing structural members having a duct. A further advantage of providing the conduit inside the duct is that the overall size of the structural member does not have to be increased, as it would if the conduit were located externally of the duct. The conduit is less likely to be damaged than if it were, for example, cast into the structural member during the manufacture of the structural member.

The temperature of the air passed along the duct may be adjusted by passing thermal energy transfer fluid along the conduit, and enabling thermal energy transfer between the air passed along the duct and the thermal energy transfer fluid.

Controlling the temperature of the thermal load may include enabling radiant thermal energy transfer between the structural member and the thermal load.

The rate of thermal energy transfer between the structural member and the thermal load may be adjusted by adjusting the temperature of the structural member by passing thermal energy transfer fluid at a temperature different from that of the structural member, through the conduit and enabling thermal energy transfer between the structural member and the fluid. The method may include heating or cooling the thermal energy transfer fluid exteriorly of the structural member.

A method according to any one of claims 2 to 8 including adjusting the relative amounts of thermal energy transfer between the structural member and the thermal load and between the air passed through the structural member and the thermal load.

According to a second aspect of the invention, there is provided a temperature control apparatus for controlling the temperature of a thermal load, the temperature control apparatus including a structural member which includes at least one hollow duct through which air can pass in thermal contact with the structural member, the structural member also including an inlet for receiving air to be passed through the duct and an outlet through which air which has passed through the duct may leave the structural member, the structural member further including a conduit for carrying thermal energy transfer fluid, the conduit being positioned within the duct, in thermal contact with the structural member, and with air which passes through the duct.

The structural member may include material having a high thermal mass, for example the structural member may be manufactured from concrete.

For ease of manufacture, the structural member may include a plurality of substantially side-by-side ducts, each duct being separated along a majority of its length from an adjacent duct by a rib, each of the ducts being communicable with an adjacent duct, via an opening in the rib.

The openings between adjacent ducts may be positioned at or near longitudinal ends of the ducts, for example at or adjacent edges of the structural member. By providing alternate ducts at opposite edges of the structural member, the ducts and openings may create a “serpentine” air flow passage between the inlet and the outlet.

The conduit may be positioned near to a base part of the duct, preferably embedded in material which is in direct thermal contact with the duct to provide good conductive thermal energy transfer between the thermal energy transfer fluid in the conduit and the structural member.

The conduit may be flexible.

The thermal energy transfer fluid is preferably a liquid, and may be predominantly water.

According to a third aspect of the invention there is provided a method of manufacturing a temperature control apparatus according to the second aspect of the invention including casting the duct in the structural member.

The method may include feeding the conduit through the duct via an access opening.

The method may include providing the conduit in a plurality of parts, and joining the parts of the conduit together using one or more connectors.

The method may include locating the conduit at or near a base part of the duct, and preferably embedding the conduit by a layer of material to maintain the conduit in thermal contact with the duct.

According to a fourth aspect of the present invention, there is provided a structure including a temperature control apparatus according to the second aspect of the invention.

The structure may be a building.

The structural member of the temperature control apparatus may form a part of at least one of a floor and a ceiling of the structure.

The invention will now be described, by way of example only, and with reference to the accompanying drawings, of which:

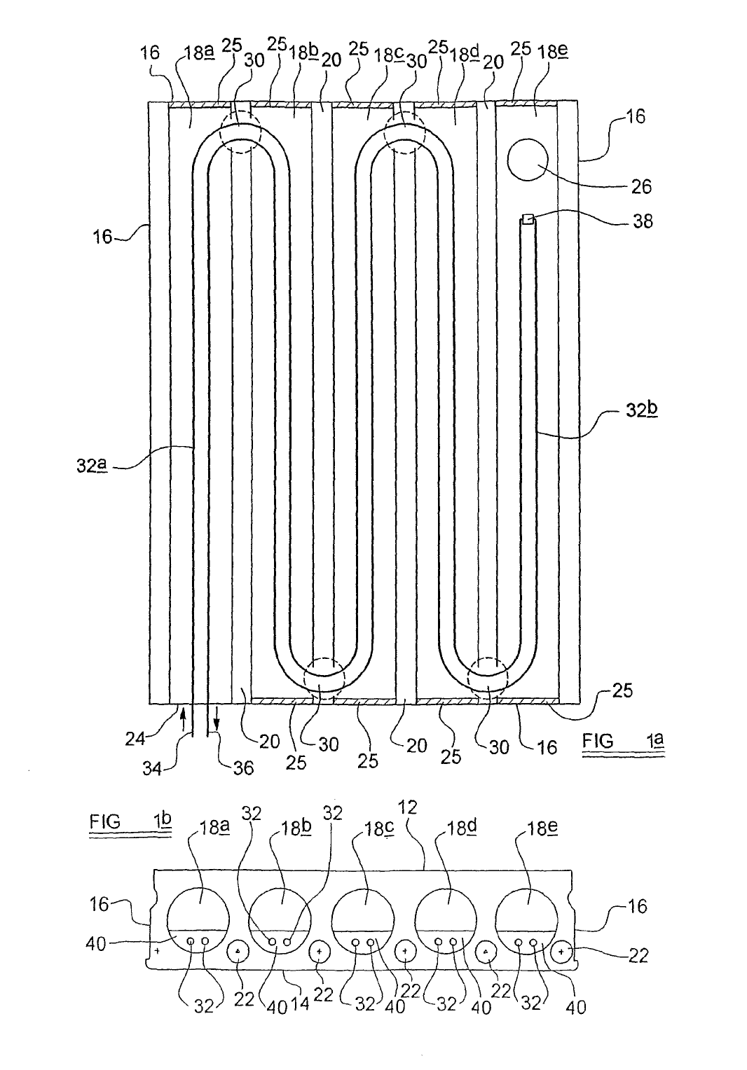

FIG. 1A is a first cross-sectional view of a structural member for use in controlling the temperature of a thermal load in accordance with a method according to the present invention,

FIG. 1B is a second cross-sectional view of the structural member,

FIG. 2 is a perspective view of a part of the structural member,

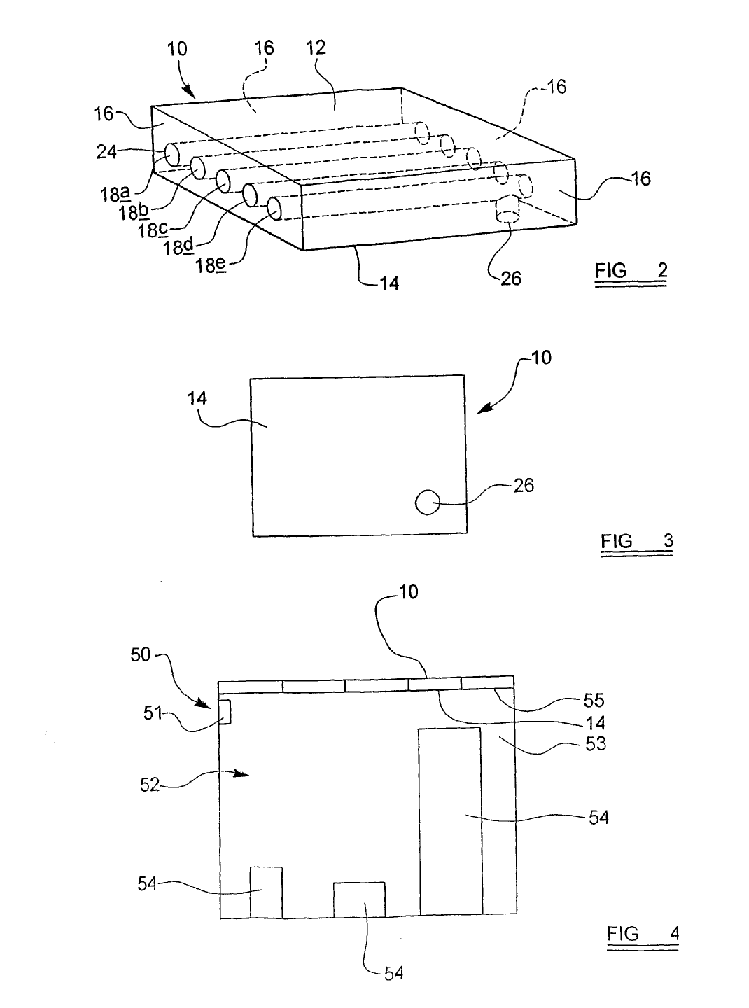

FIG. 3 shows the lower face of the structural member, and

FIG. 4 is a cross-sectional view of a structure including a structural member as shown in FIGS. 1 to 3.

As shown in FIGS. 1 to 3, there is provided a structural member 10 which has a upper face 12, a lower face 14 and four side walls 16. The structural member 10 is substantially rectangular in cross section in this example. The structural member 10 is preferably manufactured from concrete.

The structural member 10 may be used to construct a building structure in known fashion, and may form a part of a wall, a ceiling or a floor of a structure for example. A plurality of similar structures are connectable together to construct a light, yet strong structure.

The structural member 10 may include one or more strengthening elements, for example pre-tensioned steel wires 22, which are stretched to impart a permanent stress to the concrete, when the structural member 10 is manufactured.

The structural member 10 includes at least one hollow duct 18 which extends longitudinally from one side wall 16 to an opposite side wall 16. The or each hollow duct 18 is substantially circular in cross section, and is formed into the structural member 10 during the manufacture of the structural member 10, for example using cores. The structural member 10 in this example includes five hollow ducts 18a, 18b, 18c, 18d, 18e, which are substantially parallel to one another. It will be appreciated that the structural member 10 may include any number of hollow ducts 18 and each hollow duct 18 may have any cross-sectional shape. Each hollow duct 18 a-e is separated from an adjacent hollow duct 18a-e by a rib 20 of concrete. The shape and size of the ducts 18 a-e is dependent on the depth of the structural member 10. For example the diameter of the ducts 18 a-e may be between 170 mm and 300 mm. Where the depth of the structural member 10 is 260 mm, the ducts 18a-e are preferably circular in cross-section, having a diameter of approximately 175 mm; where the depth of structural member 10 is 320 mm, the ducts 18a-e are preferably substantially elliptical, having a width of approximately 222 mm and a length of approximately 240 mm; and where the depth of the structural member 10 is 400 mm, the ducts 18 a-e are substantially elliptical, having a width of approximately 218 mm and a length of approximately 295 mm.

Air may be passed along each hollow duct 18a-e. The structural member includes an inlet 24, for receiving air into at least one of the ducts 18a-e of the structural member 10. The inlet 24 is formed by one end of one of the ducts 18a-e. Each end of each of the remaining ducts 18a-e is preferably blocked, for example, by a plug 25. In the present example, the inlet 24 is positioned at a first end of a first longitudinal duct 18a. It will be appreciated that the inlet 24 may alternatively be produced by forming an opening in one of the side walls 16, or in the upper face 12 or the lower face 14 of the structural member 10, such that the opening is fluidly communicable with at least one of the ducts 18a-e. The cross sectional area of each of the ducts 18a-e is selected so as to obtain a desired rate of flow of air along the ducts 18a-e. The flow rate may be selected to be any rate as required, but in the present example is two metres per second.

The structural member also includes an outlet 26. The outlet 26 is fluidly communicable with at least one of the ducts 18a-e. In the present example, the outlet 26 is fluidly communicable with the fifth duct 18e, i.e. the duct 18 which is furthest away from the first duct 18a which is fluidly communicable with the inlet 24. In this example, the outlet 26 is positioned in the lower face 14 of the structural member 10. However, as will be described in more detail below, the outlet 26 may alternatively be positioned in any of the side walls 16, or in the upper face 12 of the structural member 10, dependent on whether the structural member 10 forms a part of a floor, ceiling or wall of a building.

The structural member 10 is modifiable either off-site, as a manufacturing process, or on-site, as it is used in the construction of a building structure, so that each of the ducts 18a-e is fluidly communicable with at least one adjacent duct 18a-e. In order to connect one duct 18a-e to an adjacent duct 18a-e, a part of the rib 20 which separates one duct 18a-e from an adjacent duct 18a-e is removed. It is possible to remove this part of the rib 20 by drilling an opening or “crossover” 30 into the upper face 12 or lower face 14 of the structural member 10, such that the opening 30 fluidly connects the two adjacent ducts 18a-e. The opening 30 is preferably positioned at or near a corresponding longitudinal end of the two adjacent ducts 18a-e. The opening 30 in the upper face 12 or lower face 14 is preferably blocked after the fluid connection has been made between the adjacent ducts 18a-e, so that the ducts 18a-e remain fluidly communicable, but so that the upper face 12 or lower face 14 does not include unnecessary and potentially unsightly openings.

An opening 30 is provided between each of the adjacent ducts 18a-e, with the openings 30 between ducts 18a and 18b, and between ducts 18c and 18d being provided at the first longitudinal end of the ducts 18a-e, and the openings between ducts 18b and 18c, and between 18d and 18e being positioned at or near a second longitudinal end of the respective ducts. Thus a “serpentine” air flow passage between the inlet 24 and the outlet 26 is provided by the ducts 18a-e and the openings 30.

A conduit 32 for carrying thermal energy transfer fluid is positioned in at least one of the ducts 18a-e. The conduit 32 includes a first end 34 and a second end 36. The conduit 32 is preferably flexible, and is manufactured from a plastics material, for example. In a preferred embodiment, both the first end 34 and the second end 36 of the conduit 32 are positioned at or near to the inlet 24 of the duct. The conduit 32 passes along each of the ducts 18a-18e in a serpentine manner, the conduit 32 passing through each of the openings 30 between adjacent ducts 18a-18e.

The conduit 32 is provided in a plurality of parts, in this example two parts, a first part 32a, and a second part 32b. A connector 38 is provided for joining the parts of the conduit 32 together so as to permit fluid communication between each part 32a, 32b of the conduit 32. The first part 32a extends from the inlet 24, along each of the ducts 18a-e, in succession. The second part 32b of the conduit 32 is connected to the first part 32a by the connector 38 which is positioned in the duct 18e, near to the outlet 26. The second part extends from the connector 38 along each of the ducts 18e-a, following the path of the first part 32a in reverse, back to the inlet 24. The first and second parts 32a, 32b are therefore substantially parallel, or at least alongside one another, along the majority of their respective lengths, the first part 32a acting as a supply line for the thermal energy transfer fluid, and the second part 32b being a return line for the thermal energy transfer fluid. This arrangement assists in maintaining a balanced temperature across the whole structural member 10 when thermal energy transfer fluid is passed through the conduit 32.

The first and second parts 32a, 32b of the conduit 32 are preferably fed into the ducts 18 via the outlet 26. The connector 38 is also receivable in the duct 18e via the outlet 26, so as to enable continuous flow of thermal energy transfer fluid through the conduit 32, from the inlet 24, through each of the ducts 18a-e, towards the connector 38 near the outlet 26, and then returning from the connector 38, through each of the ducts 18e-a, to the inlet 24. Positioning the connector 38 near to the outlet 26 enables easy access to the connector 38, for maintenance or replacement. The outlet 26 thus provides an access opening for the conduit 32 and the connector 38.

The conduit 32 is preferably located at or near a base part of the ducts 18a-e. For example, when the structural member 10 is oriented as it would be when forming a floor or a ceiling of a structure, the conduit 32 lies towards the bottom of each duct 18a-e. In this example, the conduit 32 is circular in cross-section, although it will be appreciated that the conduit 32 may be any shape. The cross-sectional diameter of the conduit 32 is preferably between 16 mm and 25 mm.

The conduit 32 is preferably embedded in a thin layer of material 40, to maintain the conduit 32 in good, direct, thermal contact with the structural member 10. For example a quantity of concrete may be poured into one or more of the ducts 18a-e, so as to flow over the conduit 32, to hold the conduit 32 in position as the concrete sets. The material forming the layer 40 is preferably self-levelling, and provides a substantially planar upper surface when the material sets. The layer of material is preferably approximately 3 mm deeper than the diameter of the conduit 32, but it will be appreciated that the layer may be any thickness, provided that the layer does not obstruct the ducts 18 to such an extent that air is unable to pass along the ducts 18.

A further advantage of embedding the conduit in the layer of material 40 is that in the event that dust and/or other debris collects in ducts 18a-e, the ducts 18a-e can be more easily cleaned, and without damaging the conduit 32. Furthermore, debris is less likely to become trapped in the ducts 18a-e during cleaning, if the ducts 18a-e have a substantially planar lower surface, rather than a ridged lower surface as would be the case if the conduit 32 was not covered by the layer of material 40. It will be appreciated that the layer of material 40 is, though, optional, and may be omitted as required, but desirably, the conduit 32 is, in that case, in direct contact with the walls of the ducts to provide good thermal conduction. It will be appreciated that where a layer of material 40 is provided, the thickness of the layer of material 40 may be such that the conduit 32 is partially embedded, shallowly embedded or deeply embedded in the layer of material 40.

The structural member 10 may have the openings 30 formed, and the conduit 32 inserted as a manufacturing step, or alternatively the openings 30 may be formed and the conduit 32 may be inserted on-site, prior to the structural member 10 being used to construct a structure.

FIG. 4 shows a plurality of structural members 10 forming a part of a building structure 50. The building structure 50 includes a room 52, which holds a volume of air 53. The room 52 may also include one or more objects 54, including other parts of the structure 50, furniture, and/or people for example. The volume of air 53 and the objects 54 are a thermal load of the structure 50. In this example the structural member 10 forms part of a ceiling 55 of the structure 50, so that the lower face 14 of the structural member 10 faces inwardly of the room 52. However, it will be appreciated that the structural member 10 may be used to construct any part of the structure 50. It will be appreciated that any number of structural members 10 may be used in the construction of the structure 50.

The structural member 10 is part of a temperature control apparatus, for controlling the temperature of the thermal load in the structure 50. It will be appreciated that the structure 50 may include more than one temperature control apparatus, so as to enable the temperature control of different thermal loads in individual rooms or areas of the structure 50.

The temperature control apparatus includes at least one sensor for detecting the temperature of the thermal load within the structure 50. The temperature control apparatus also includes sensors for detecting the temperature of the structural member 10 and the temperature of ambient air externally of the structure 50. The temperature control apparatus also includes a control unit 51 for receiving data from the sensors, and controlling the operation of the temperature control apparatus.

As described above, it is desirable for the temperature of the volume of air 53 in the room 52, and/or the temperature of the objects 54, in particular human occupants, and certain temperature sensitive objects, for example electrical equipment, to be maintained within a range of comfortable temperatures. The range of comfortable temperatures, i.e. predetermined upper and lower temperature limits, may be input into the control unit 51.

The overall or resultant transfer of thermal energy between the structural member 10 and the thermal load is a combination of radiant thermal energy transfer and convective thermal energy transfer. The transfer of thermal energy between the structural member 10 and objects 54 in the room 52 is predominantly radiant thermal energy transfer, whereas the transfer of thermal energy between the structural member 10 and the volume of air 53 is predominantly convective.

The structural member 10 has a high thermal mass, therefore it will be appreciated that structural member 10 absorbs and transfers thermal energy more slowly than materials having a lower thermal mass, for example the air surrounding the structural member 10. The temperature of the structural member 10 therefore has a tendency to lag behind the temperature of the environment in which the structural member 10 is located.

To explain this temperature lag in greater detail, during the daytime, for example, when the temperatures of the thermal load and the ambient air externally of the structure 50 are generally warm relative to the temperature of the structural member 10, the structural member 10 absorbs thermal energy from the thermal load and air passing through the ducts 18a-e which originates externally of the structure 50. During the night, the temperatures of the thermal load and the ambient air externally of the structure 50 are usually relatively cool, compared with the temperature of the structural member 10, and the structural member 10 is able to transfer at least a proportion of its absorbed thermal energy to its surroundings. The thermal energy can be transferred externally of the structure 50, for example by piping or venting fluid which is in thermal contact with the structural member 10 away from the structure 50.

The time lag in temperature change of the structural member 10 enables the structural member 10 to adjust the temperature of the thermal load to a certain degree, dependent on the temperature difference between the structural member 10 and the thermal load.

The first sensor repeatedly or continuously checks the temperature of the volume of air 53 and/or an object 54 in the room 52, i.e. the temperature of the thermal load. The control unit 51 determines whether any temperature adjustment is required, for example, in the event that the temperature of the thermal load is above the upper limit, then it is desirable to operate the temperature control apparatus to reduce the temperature of the thermal load. Similarly, in the event that the temperature of the thermal load is below the lower limit, then the temperature control apparatus is operable to raise the temperature of the thermal load. The control unit 51 may also operate the temperature control apparatus in the event that the temperature of the thermal load is moving towards the upper or lower limit, or has reached a temperature which is considered sufficiently close to the upper or lower limit for temperature adjustment to be required.

It will be appreciated that the temperature of the thermal load may rise significantly in a short period of time, for example if the room 52 is occupied by a large number of people, or particularly if the number of occupants of the room 52 increases quickly. In the event that the temperature of the thermal load is increasing, such that the temperature falls outside the predetermined upper limit, or the control unit 51 determines that the temperature is likely to fall outside the predetermined upper limit, the control unit 51 operates the temperature control apparatus so as to transfer thermal energy away from the thermal load.

The temperature of the thermal load may rise so quickly that the structural member 10 is unable to absorb sufficient thermal energy from the thermal load quickly enough to maintain the temperature of the volume of air 53 within the predetermined comfortable limits. Therefore it is desirable to provide supplementary cooling of the volume of air 53 and/or the object.

The control unit 51 takes into account various factors, including, for example the temperature of the thermal load, the temperature of the structural member 10, and the temperature of the external ambient air, in order to determine the most appropriate method of temperature control. The control unit 51 is capable of determining the optimum method of controlling the temperature of the thermal load. For example, the control unit 51 determines whether the difference in temperatures of the structural member 10 and the thermal load is sufficient to provide adequate radiant thermal energy transfer, or whether there is a sufficient difference in the temperatures of the ambient external air and the thermal load, to provide adequate convective thermal energy transfer by passing the ambient external air through the ducts 18a-e of the structural member 10 into the room 52.

The control unit 51 is operable to determine the optimum relative amounts of radiant and convective thermal energy transfer, for a given set of conditions, and to operate the temperature control apparatus accordingly, so as to provide efficient temperature control within an acceptable time period.

In the event that the control unit 51 determines that the difference between the temperature of the ambient air externally of the structure 50 and the temperature of the volume of air 53, is sufficient to enable the temperature of the thermal load to be adjusted predominantly by convective means, in addition to the radiant thermal energy transfer which the structural member 10 is capable of providing, the control unit 51 operates the temperature control apparatus to pass a quantity of ambient air from outside the structure 50 into the inlet 24 of the structural member 10, through the ducts 18a-e, and into the room 52 via the outlet 26. The external ambient air may be drawn or urged into and through the ducts of the structural member 10 by a fan, pump or impeller, for example. The mixing of this cooler external ambient air with the volume of air 53, will cause the overall temperature of the volume of air 53 to decrease. Objects 54 which are close to the outlet 26 may also feel a cool draught as the ambient external air enters the room 52 through the outlet 26. This method of cooling uses convective thermal energy transfer to adjust the temperature of the thermal load. It is possible for the external ambient air to be pre-treated, to adjust its temperature, prior to the air entering the structural member 10.

However, as the external ambient air passes through the ducts 18a-e, the air is in thermal contact with the structural member 10, and in the event that the structural member is warmer than the ambient air, the ambient air will absorb thermal energy from the structural member 10, and hence the temperature of the ambient air will tend to increase. This is disadvantageous as far as convective thermal energy transfer is concerned, as the ability of the air to perform adequate thermal energy transfer is diminished. It would be possible to compensate for this increase in temperature of the air, by pre-treating the air to be passed through the ducts 18a-e so that the temperature of the air is below that which would ultimately be required for adequate thermal energy transfer. However, it will be appreciated that this is inefficient.

The effect of the air which passes through the ducts 18a-e absorbing thermal energy from the structural member 10 can be used advantageously to control the temperature of the structural member 10, so as to improve the radiant thermal energy transfer between the structural member 10 and the thermal load. Since the structural member 10 has a high thermal mass, the thermal energy can be effectively stored by the structural member for later use. For example, the structural member 10 may be cooled by cool ambient air supplied from the exterior of the structure 50 during the night, by transferring at least a proportion of its thermal energy to the ambient air, thus enabling the structural member 10 to absorb thermal energy from the thermal load during the day. Alternatively or additionally, it is possible for the thermal energy absorbed by the structural member 10 during the day to be stored and transferred back to the thermal load when the temperature of the thermal load is below the desired temperature range, so as to increase the temperatures of the volume of air 53 and/or the objects 54.

In some circumstances, for example where a large change in the temperature of the thermal load occurs in a short period of time, the thermal energy in the room 52 may increase to such a level or at such a rate that the temperature control system is unable to maintain the temperature of the thermal load within the predetermined upper and lower limits, even by the combination of the radiant thermal energy transfer of the structural member and the convective thermal energy transfer provided when cooler external ambient air is passed through the structural member 10. In these circumstances, the temperature control system is operable to circulate thermal energy transfer fluid through the conduit 32. The thermal energy transfer fluid is preferably water but may be another liquid, for example, a refrigerant.

In order to effect cooling of the thermal load, the thermal energy transfer fluid is supplied at a temperature which is lower than the temperature of the structural member 10 and preferably lower than the temperature of the external ambient air. The thermal energy transfer fluid may be pre-treated prior to entering the structural member 10, so as to adjust the temperature of the thermal energy transfer fluid to a desired temperature. It is easier to adjust the temperature of a liquid than a gas; therefore the thermal energy transfer fluid can be adjusted to the desired temperature quickly, and the temperature adjustment is more efficient.

Since the conduit 32 is located in thermal contact with the ducts 18a-e, the thermal energy transfer fluid is also in thermal contact with air which passes through the ducts 18a-e. Therefore passing thermal energy transfer fluid through the conduit 32 enables the temperature of the ambient air being passed through the ducts 18 to be adjusted before the air enters the room 52 via the outlet 26. This enables the convective thermal energy transfer between the ambient air and the volume of air 53 to have a greater effect than if no thermal energy transfer fluid is passed through the conduit 32. An advantage of this is that the temperature of the air passing through the ducts 18a-e can be adjusted to the desired level for optimum thermal energy transfer shortly before the air is passed into the room 52. This reduces the problem of the air absorbing thermal energy from the structural member 10.

The thermal energy transfer fluid is also able to absorb thermal energy from the structural member 10 via conduction, so as to reduce the temperature of the structural member 10. The decrease in the temperature of the structural member 10 enables the structural member 10 to absorb further thermal energy from the thermal load, so as to decrease the temperature of the thermal load. The thermal energy transfer fluid is capable of transferring thermal energy to/from the structural member 10 more quickly than air; for example approximately fourteen times more quickly than air.

This increases the efficacy of both the radiant and convective thermal energy transfer between the structural member 10 and the object 54 and the volume of air 53, respectively.

The relative amounts of radiant and convective thermal energy transfer provided by the temperature control apparatus are dependent on the difference in temperature (ΔT) between the thermal energy transfer fluid and the structural member 10 and between the thermal energy transfer fluid and the air passing through the duct 18 respectively. The greater the difference in temperature the greater the likelihood of thermal energy transfer by the thermal energy transfer fluid.

In addition to the dependency of the relative amounts of radiant and convective thermal energy transfer on the differences in temperature between the thermal energy transfer fluid and the structural member and the air passing through the duct, respectively, the position of the conduit 32 in the ducts 18a-e affects the relative amounts of thermal energy transfer which are possible between the thermal energy transfer fluid and the structural member 10 and between the thermal energy transfer fluid and the air passing through the ducts 18a-e. These relative amounts of thermal energy transfer affect whether it is radiant thermal energy transfer (i.e. between the structural member 10 and the object 54) or convective thermal energy transfer (i.e. between the ambient air passed through the ducts 18a-e and the volume of air 53) which is the predominant method of thermal energy transfer. The closer the conduit 32 is to the face of the structural member 10 which is in thermal contact with the room 52 (in this case lower face 14) the greater the ratio of the effect of the thermal energy transfer fluid on the radiant thermal transfer, to the effect of the thermal energy transfer fluid on the convective thermal energy transfer.

Where no thermal energy transfer fluid is passed through the conduit 32, and with moderate external ambient temperatures, or relatively constant internal thermal loads, it is likely to be unnecessary to pass thermal energy transfer fluid through the conduit 32, and in this circumstance, radiant thermal energy transfer accounts for approximately 70% of the thermal energy transfer occurring within the structure 50, and convective thermal energy transfer accounts for approximately 30% of the total thermal energy transfer occurring. This combined effect of the thermal energy transfer between the ambient air and the thermal load and between the structural member and the thermal load, enables an adequate degree of temperature adjustment in these conditions.

Where thermal energy transfer fluid is passed through the conduit 32, convective thermal energy transfer accounts for approximately 40% of the total thermal energy transfer from/to the thermal load, and radiant thermal energy transfer accounts for approximately 60% of the total thermal energy transfer.

It is possible to use the temperature control apparatus to increase the temperature of the thermal load. This can be done by supplying ambient external air which is at a higher temperature than the thermal load, through the ducts of the structural member 10. If the temperature difference between the external ambient air and the thermal load is insufficient to enable adequate temperature adjustment of the thermal load, then it is possible to increase the temperature of the ambient air by pre-treating the air prior to the air entering the structural member 10. Alternatively, or additionally thermal energy transfer fluid which is at a higher temperature than the thermal load, and preferably higher than the temperature of the air passing through the duct 18, may be passed through the conduit 32, so as to transfer thermal energy to the thermal load via convection, and by radiant thermal energy transfer via the structural member 10.

It will be appreciated that other duct layouts are possible and that ducts and/or conduits having different dimensions from those specified herein may be provided. It will be appreciated that the larger the diameter of the duct and or the conduit, the better the rate of flow of fluid, but the more difficult the provision of such ducts/conduits.

It will be appreciated that the conduit 32 may be provided in any number of the ducts 18 of a structural member 10, and it is possible to use one or more of the ducts 18 to receive apparatus other than temperature control apparatus, for example electrical cables.

The temperature control apparatus may include a fan for adjusting the flow rate of, or heating or cooling, the external ambient air through the ducts 18.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of controlling the temperature of a thermal load within a structure, including providing a structural member which has a high thermal mass, the temperature of the thermal load being controlled by permitting thermal energy transfer between the structural member and the thermal load, the method including providing the structural member with at least one duct for receiving a supply of air, and an outlet for enabling the supply of air to flow from the duct to the thermal load, so as to enable convective thermal energy transfer between the air passed along the duct and the thermal load, wherein the thermal energy transfer between the air passed along the duct and the thermal load is controlled by adjusting the temperature of the air passed along the duct, the method further including providing a conduit for carrying thermal energy transfer fluid in the duct, the conduit being in thermal contact with the duct of the structural member and the air passing through the duct.

2. A method according to claim 1 wherein the temperature of the air passed along the duct is adjusted by passing thermal energy transfer fluid along the conduit, and enabling thermal energy transfer between the air passed along the duct and the thermal energy transfer fluid.

3. A method according to claim 1 wherein controlling the temperature of the thermal load includes enabling radiant thermal energy transfer between the structural member and the thermal load.

4. A method according to claim 1 wherein the rate of thermal energy transfer between the structural member and the thermal load is adjusted by adjusting the temperature of the structural member by passing thermal energy transfer fluid at a temperature different from that of the structural member through the conduit and enabling thermal energy transfer between the structural member and the fluid.

5. A method according to claim 4, wherein the rate of thermal energy transfer between the structural member and the thermal load is increased by passing thermal energy transfer fluid at a temperature different from that of the structural member through the conduit and enabling thermal energy transfer between the structural member and the fluid.

6. A method according to claim 2 including adjusting the temperature of the thermal energy transfer fluid prior to the thermal energy transfer fluid entering the structural member.

7. A method according to claim 2 including adjusting the relative amounts of thermal energy transfer between the structural member and the thermal load and between the air passed through the structural member and the thermal load.

8. (canceled)

9. A temperature control apparatus for controlling the temperature of a thermal load, the temperature control apparatus including a structural member which includes at least one hollow duct through which air can pass in thermal contact with the structural member, the structural member also including an inlet for receiving air to be passed through the duct, and an outlet through which air which has passed through the duct may leave the structural member, the structural member further including a conduit for carrying thermal energy transfer fluid, the conduit being positioned within the duct, in thermal contact with the structural member, and with air which passes through the duct.

10. A temperature control apparatus according to claim 9 wherein the structural member includes material having a high thermal mass

11. A temperature control apparatus according to claim 9 wherein the structural member is manufactured from concrete.

12. A temperature control apparatus according to claim 9 wherein the structural member includes a plurality of substantially side-by-side ducts, each duct being separated along a majority of its length from an adjacent duct by a rib, each of the ducts being communicable with an adjacent duct, via an opening in the rib.

13. A temperature control apparatus according to claim 12 wherein the ducts and openings create a “serpentine” passage between the inlet and the outlet.

14. A temperature control apparatus according to claim 12 wherein the conduit is positioned near to a base part of the duct.

15. A temperature control apparatus according to claim 12 wherein the conduit is flexible.

16. A temperature control apparatus according to claim 9 wherein the thermal energy transfer fluid is a liquid.

17. A temperature control apparatus according to claim 12 wherein the thermal energy transfer fluid is predominantly water.

18. (canceled)

19. A method of manufacturing a temperature control apparatus according to claim 9 including casting the duct in the structural member.

20. A method according to claim 19 including feeding the conduit through the duct via an access opening.

21. A method according to claim 20 including embedding the conduit in a layer of material, to maintain the conduit in thermal contact with the duct.

22. (canceled)

23. A structure including a temperature control apparatus according to claim 9.

24. A structure according to claim 23 wherein the structure is a building.

25. A structure according to claim 24 wherein the structural member of the temperature control apparatus forms a part of at least one of a floor and a ceiling of the structure.
